(19) United States
(12) Patent Application Publication
(10) Pub. No.: US 2016/0028660 A1
(43) Pub. Date: Jan. 28, 2016

(54) PRIVATE CHAT ROOM

(71) Applicant: Life of Two, Inc., San Francisco, CA (US)

(72) Inventors: Bianca Weishaupl, San Francisco, CA (US); Oscar Salazar, New York, NY (US)

(21) Appl. No.: 14/339,353

(22) Filed: Jul. 23, 2014

(51) Int. Cl. H04L 12/58; H04L 29/08; H04L 29/06

(52) U.S. Cl. CPC H04L 51/04; H04L 65/403; H04L 67/10

(57) ABSTRACT

Chat rooms and other messaging applications allow users to share messages, images, and other digital content with one another. Messaging applications may be configured to remove content exchanged between users from their devices in response to a user leaving closing a communication channel or otherwise terminating the chat session. Content may be removed from a device executing the messaging application, and/or any device that stored a copy of the content. Some messaging applications may require users to transfer a key before such a transient chat room may be created, such that the users are provided with an additional layer of protection.

### TECHNICAL FIELD

The present technology pertains to sending data between electronic devices, and more specifically to systems for facilitating the sending, receiving, and removal of messages.

### BACKGROUND

For many, email, instant messaging, and social networking have become everyday forms of communication. Indeed, the rapid adoption of smartphone usage has increased the use of these digital communication means such that their use is nearly ubiquitous in many communities.

While there is an abundance of messaging systems, many do not provide proper safeguards when a user wants to send confidential information, or in particular, information that another user may only view for a limited amount of time.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, devices, and non-transitory computer readable storage media for implementing messaging applications that transfer transient content. Transient content, as described herein, refers to content that is available for a particular amount of time.

Messaging applications allow users to create and use messaging sessions (also known as “chat sessions” or “chat rooms”) where messages, images, and other digital content may be exchanged. In embodiments described herein, when a user ends a messaging session, the content exchanged during the session is deleted from all user devices that partook in the session. For example, two users may decide that they would like to have a chat session that is deleted when finished. At the same time, the two users do not want the messages and images to be deleted before the end of the chat session. Embodiments described herein allow users to have long, private conversations which are then inaccessible to any of the users at a later time. Using a messaging system such as the one discussed herein, users can feel free to share intimate messages with loved ones, share confidential information, or hold conversations with lawyers, psychologists, spiritual advisors, etc. Once a conversation is finished, a user can rest assured that their conversation cannot be viewed by someone using a device that was privy to the conversation.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary electronic environment in which methods and systems discussed herein can be executed;

FIGS. 2A, 2B, 2C, 2D, and 2E illustrate an exemplary embodiment of a messaging application interface that allows users to share content;

FIG. 3 illustrates an exemplary method embodiment of implementing an exemplary messaging application; and

FIGS. 4A, and 4B illustrate exemplary electronic environments, in accordance with various embodiments.

### DESCRIPTION

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure.

Methods and systems described herein allow users to transfer content such that that the content is only available for a particular period of time. In embodiments described herein, a user may access an instant messaging application that allows for the creation and use of transient chat rooms (e.g., chat rooms that contain temporary content). When the transient chat rooms are terminated (e.g., when a chat session ends), the content exchanged between the parties becomes inaccessible to all of the parties. For instance, messaging applications may not save the exchanged content in a local device's memory and/or delete the exchanged content from a local device when a transient messaging session is terminated by any party. In one example, exchanged content may only be stored in a cache within a local device, and not in a main memory.

As used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

As used herein, the term “user” shall be considered to mean a user of an electronic device(s). Actions performed by a user in the context of computer software shall be considered to be actions taken by a user to provide an input to the electronic device(s) to cause the electronic device to perform the steps embodied in computer software. In some embodiments, an action performed by a user may include accessing a mobile application.

As used herein the term “transient content” shall be considered to refer to content that is intended to be accessible to a user for a particular period of time. Similarly, the terms “transient chat room,” “transient chat session,” “transient messaging session,” or private chat room” may be used interchangeably and refer to a communication channel (e.g., a means of communicating) established by an application, web site, or script that allows users to exchange transient content. For instance, a chat room may refer to a communication channel initiated by an application executing on a first user device that allows for communication between the first user device and at least a second user device. The term “private chat room” may be used to describe transient chat sessions herein because it is contemplated that users may refer to a transient chat room as a private chat room since exchanged content is not available after use of the transient chat room. It should readily be apparent to those skilled in the art that the term transient content as used herein may refer to content that is intended to be transient, but may inadvertently become permanent. For example, although a user could to take a picture of the screen of a device containing messages sent between two users, these messages would still be considered transient content because they were sent with the intention of being transient.

Lastly, as used herein, the term delete may interchangeably be used with the terms “remove,” “erase,” “stopping the displaying of,” and similar terms, unless a term is explicitly used to distinguish from “delete.” The proper understanding of the term will be apparent to persons of ordinary skill in the art in the context in which the term is used.

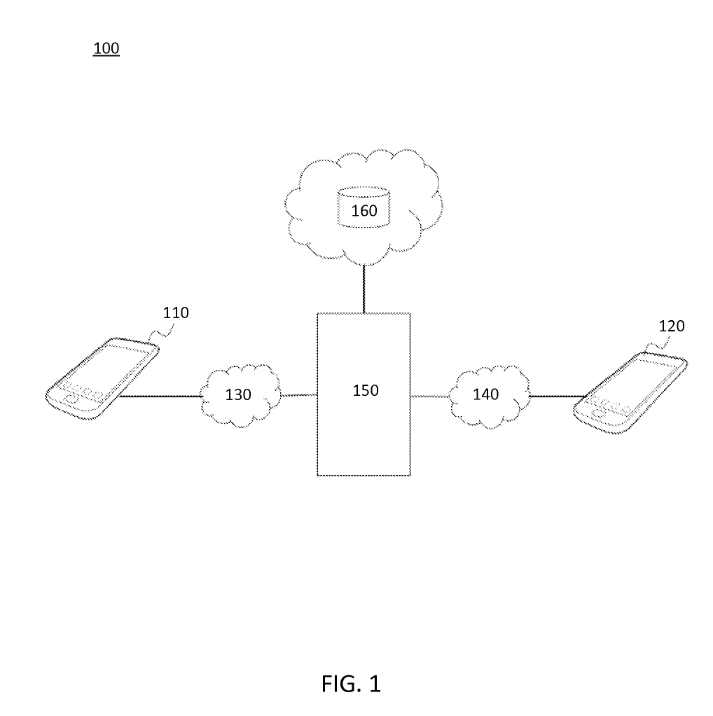

FIG. 1 illustrates an example electronic environment 100 in which methods and systems discussed herein can be executed. Two or more users can exchange digital content (messages, photos, videos, blog posts, etc.) using an application operating on electronic devices 110, 120 over one or more networks 130, 140 and by using one or more servers 150. The servers and/or devices can be configured to encrypt the digital content sent between the electronic devices 110, 120 and can be configured to store the encrypted content locally or in a network-based storage facility 160. Of course, it should be appreciated by a person of skill in the art that an example electronic environment may include more of fewer components, such as servers, storage devices, or end-user electronic devices. Further, various embodiments described herein may be configured to operate across multiple platforms (e.g., operating systems, types of devices, etc.). For example, electronic devices 110, 120 may include, but are not limited to: smart phones, hand-held computers, tablet computers, wearable computers (e.g., computers attached to glasses or other items of clothing such as buttons or hats), medical devices, personal digital assistants, laptop computers, desktop computers, etc.

As explained herein, applications executing on electronic devices 110, 120 are configured to exchange content that will be erased after a particular period of time. It is contemplated that the exchanged content may be removed from any electronic device that stores the exchanged content. For example, after a user exits a chat room, content exchanged between users of the chat room will be removed from some or all of the electronic devices 110, 120, server 150, network-based storage facility 160, and any other device that stored the exchanged content.

There are a variety of ways to remove content at the end of a transient messaging session in accordance with various embodiments. In some embodiments, the exchanged content may simply become inaccessible to the messaging application. In some embodiments, exchanged content may be deleted using an operating system's default method to delete content from a memory device included in one or more electronic devices 110, 120, server(s) 150, network-based storage facilities 160, etc. In some embodiments, exchanged content may be deleted from one or more memory devices completely and securely. While different terms may be used interchangeably throughout this specification to describe the deletion of content, such as remove, erase, delete and the like, it should be understood that any of these terms may be used to describe the deletion of one or more pieces of content from one or more devices by one or more of a plurality of methods (e.g., a different method may be used to erase content from non-volatile memory than the method used to erase content from volatile memory).

In some embodiments, media may never be stored on an electronic device. For instance, media such as text, video and/or images (e.g., an S3 Object) may only be stored in cache, or in some embodiments only a portion of a media item (or less) may be stored on a device at a particular time. As briefly discussed above, media received by a device may only be stored in volatile memory, and not to a hard disk drive. For example, received and/or sent media may only be stored in a cache. In some embodiments, the media itself may include a marker indicating that the media should not or cannot be stored to non-volatile memory or a hard disk drive. For instance, messages sent over a channel may not be archived via a flag in a PubNub publish request. As described repeatedly herein, once one or more users exit an application (e.g., by closing an application, or by terminating a process), the data stored on every device which was a part of the messaging session will be deleted. Moreover, in some embodiments, additional searches and deletion of media may be performed automatically. For instance, every twenty four hours an application may run a scan to determine if any images were inadvertently stored on an electronic device. In response to any inadvertently stored media, the electronic device may remove such media.

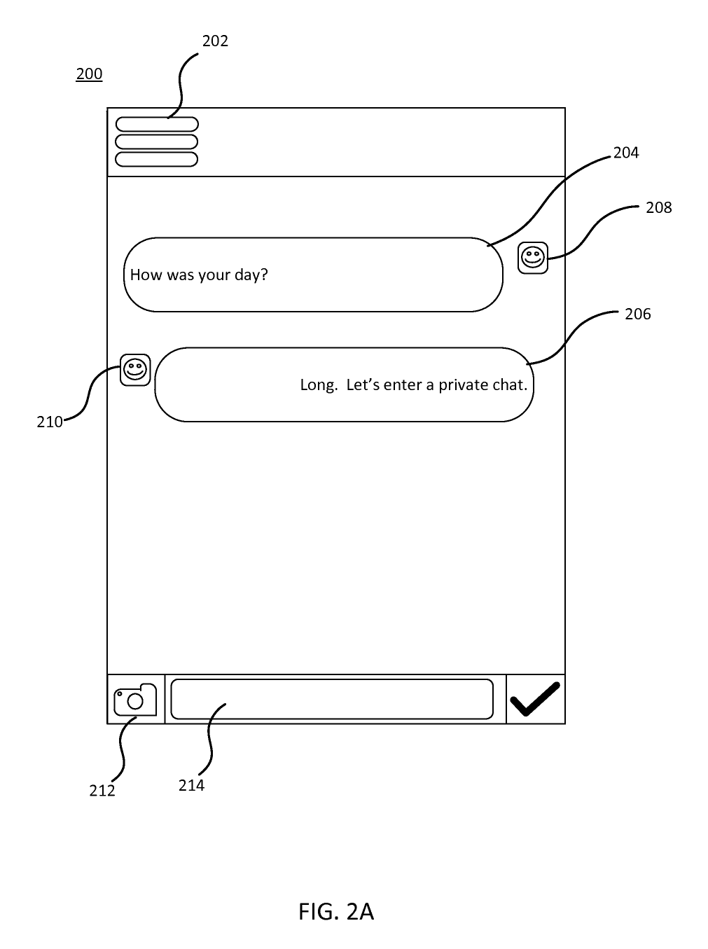

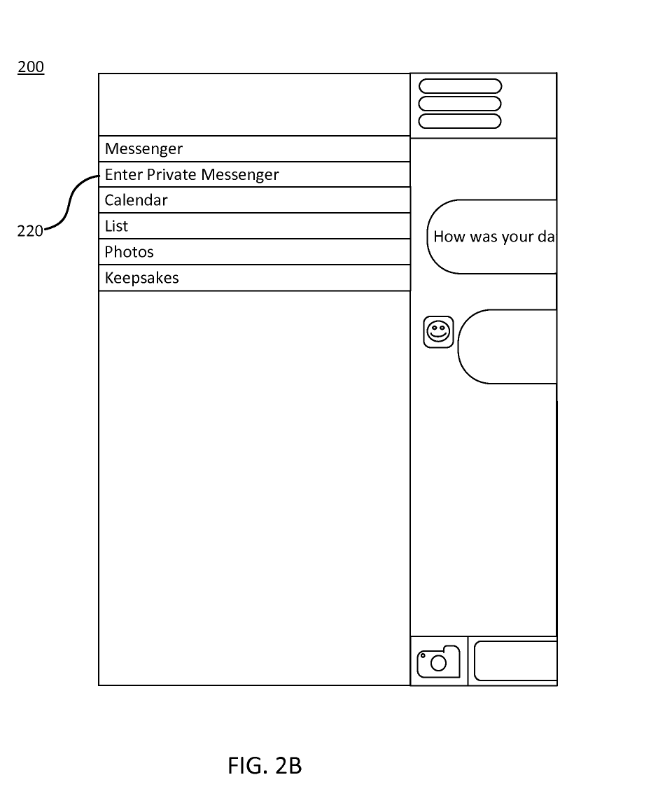

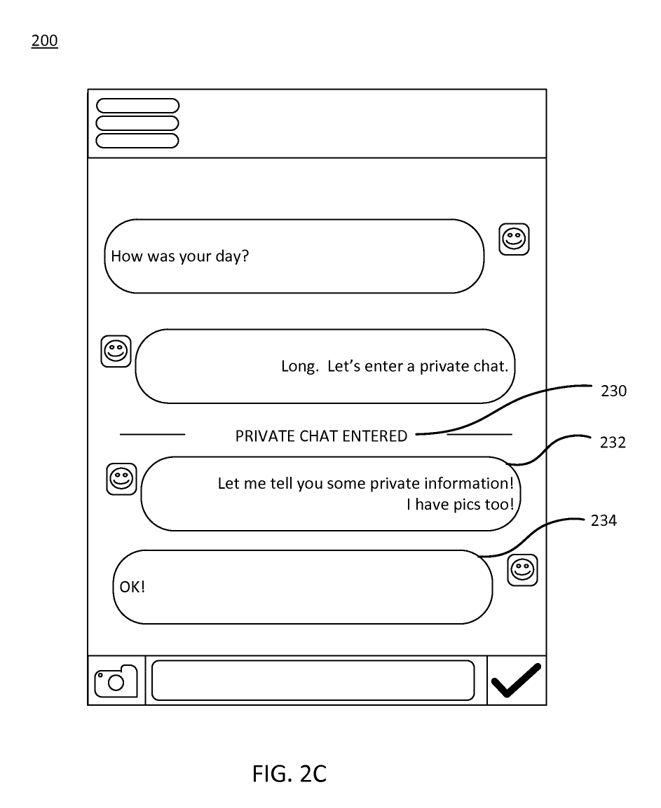

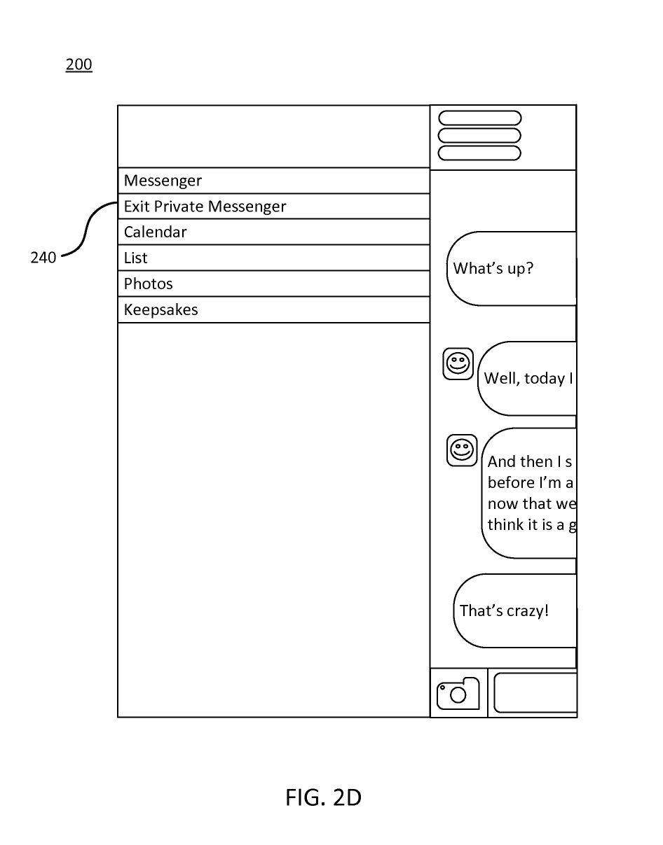

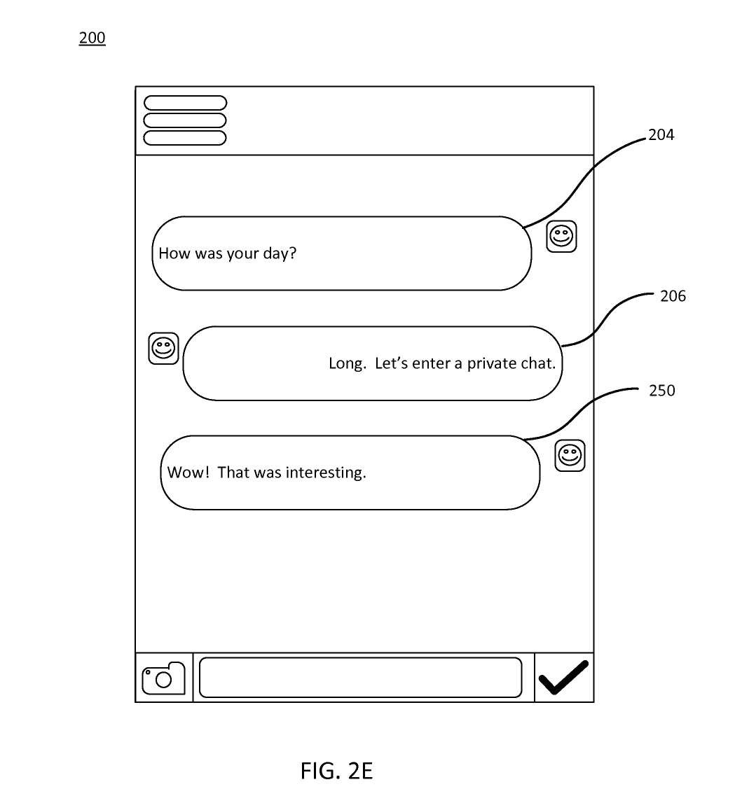

FIG. 2A illustrates an exemplary embodiment of a graphical user interface (GUI) 200 of a messaging application. The interface 200 shows a chronological series of messages 204, 206 sent back and forth between two parties. The two parties may be represented by an avatar or some other user identifier (ID) 208, 210. Of course, more than two parties may be included in a transient messaging session. The messages 204, 206 shown in FIG. 2A may include text and emoticons, however, those with ordinary skill in the art having the benefit of this disclosure will readily appreciate that a wide variety of digital content can be exchanged over the messaging application including images, videos, music files, animations, blog posts, documents, etc.

Interface 200 may include a menu button 202, a button to add an image 212, and an area to input text 214. As shown, a first user represented by ID 208 asks a second user represented by ID 210 how their day was. The second user responds to the first user that they would like to enter a private chat (i.e., enter a transient chat room/start a transient messaging session).

FIG. 2B illustrates an exemplary embodiment of the interface 200 including a menu with an “enter private messenger” button 220. By pressing or otherwise manipulating the enter private messenger button 220 a user may cause the application to start a transient chat session. It should be understood that various messaging applications may include different types of widgets and/or menus that allow a user to enter a transient chat session. For example, a button or drop down menu may be included in the interface without the need for the user to “slide” (or give the appearance of sliding) open a menu.

In some embodiments, in response to receiving a request from a first user to create a transient chat room, a notification may be sent to one or more users participating a regular, non-transient chat session indicating that the chat session has switched to a transient mode. In some embodiments a notification may be provided to the one or more users indicating that a user must pay for access to a transient chat room. For example, a first user may receive a message indicating that they must pay a fee or sign-in to their account to create a transient chat session. A user may have to make an “in-application” purchase to begin a transient session (e.g., purchase access to a transient chat room from within an application).

In some examples, a user may create a transient chat room without first creating a non-transient chat room. For example, a first user may attempt to create a transient chat room with a second user that is not currently in a regular chat room with the first user. In such an example, the attempt to create the transient chat room may cause the first electronic device 110 to send a notification to the second electronic device 120 indicating that the first user is attempting to create a transient chat session with the second user.

In some embodiments, one or more of the electronic devices 110, 120 must provide a key or other type of password to access a transient chat room. For example, the users of the electronic devices 110, 120 may contact each without using the messaging application (e.g., calling each other on the phone, emailing one another) and exchange a password. In some embodiments, a key or other password may provide a user with access to a transient chat session for a period of time (such as a week, month, or year). In some embodiments, a user may enter and exit a chat session without content exchanged within the chat session being deleted until one or more users' keys and/or passwords expire, or one or more user's request that content be deleted.

FIG. 2C illustrates an exemplary embodiment of the interface 200 including users chatting within a transient chat session. In some embodiments, a notification 230 may appear on one or more of the users' electronic devices that indicates that the users are sending messages within a transient chat session. In some embodiments, in response to a first user attempting to create a transient chat session (e.g., by pressing enter a private chat), a second user may be prompted to decide whether to enter or not enter a transient chat session initiated by the first user.

As shown in FIG. 2C, the notification 230 is shown in chronological order in the chat session. In example interface 200, transient messages 232, 234 are shown below notification 230. Again, it should be understood that transient messages 232, 234 may include various types of content including images, documents, or other files. In some embodiments, the chat session may remove all messages sent prior to entering a chat room from the chat interface such that the user explicitly understands that they have entered a transient chat room.

It is contemplated that in some embodiments, a user may circumvent the goal of the transient chat room. For example, a first user may use third party software, or an electronic device's 110 native functionality to capture and store messages, images, or other digital content. For example, an electronic device 110, 120 may be able to take a screen-shot of content displayed on a display screen of the electronic device 110, 120. In such an example, when third party software or native functionality captures content intended to be transient, such that an electronic device can store the content for an indefinite amount of time, a notification may be sent to one or more users indicating that content intended to be transitory was captured. For instance, if a first user sends an image to a second user while in the transient chat room, and the second user takes a screen shot such that their electronic device 120 may store the image, then the first user may be provided with a notification indicating that the second user took a screen shot of at least a portion of content exchanged during the transient chat session.

To prevent a user from storing content exchanged during a transient chat session, in some embodiments, a user is unable to copy or cut exchanged content. For example, a messaging application may send an instruction disabling the copy and cut functions. Similarly, in some embodiments, a user may send an instruction disabling the screen shot functionality on one or more of the electronic devices 110, 120 connected to the communication channel (i.e., the transient chat room/session). In some embodiments, the messaging application is configured to prevent a second electronic device from accessing transient content within the memory of the first electronic device. For example, a messaging application executing on a mobile device may send an instruction that disables a personal computer from accessing the transitory content temporarily stored on the mobile device.

FIG. 2D illustrates an exemplary embodiment of the interface 200 including a menu with an exit private messenger button 240. By pressing or otherwise manipulating the exit private messenger button 240 a user may cause the application to end a transient chat session. As described herein, when any user ends the transient chat session the data transferred between the devices will be deleted. Of course, in some embodiments the user that sent an image or other file stored in the memory of their electronic device 110, 120 may retain the image or file on their electronic device 110, 120. However, the user that received the file in the chat will not be able to save the image or file. It is contemplated that in some embodiments, a first user may designate at least a portion of exchanged content during a transitory chat session so that the designated portion may be saved by second user, despite the fact that the first and second user are in a transient chat room.

In some embodiments, a transient chat session includes two users, and the content sent between the two users is deleted when one of the two users terminates the transient chat session. In embodiments where more than two users participate in a transient chat session, a threshold number of users must leave or otherwise terminate their access to the chat room for transient content to be deleted. For instance, a chat room may include five (5) users. In some embodiments, the transient chat session ends and all content sent within the transient session is deleted when one of the five users exits the chat session. In some embodiments, the transient chat session ends when only a single user remains (e.g., four (4) of the five users exit the chat session).

In some embodiments, a transient chat session may end at a particular time. A transient chat session may end at a pre-determined time of day. In some embodiments, a transient chat session may end at a particular time after the transient chat session begins. For example, the creator of the transient chat session may set an amount of time for the transient chat room to exist. It may be desirable to limit a conversation with a lawyer, psychologist, or other professional that charges by the hour. In some embodiments, a messaging application allows two or more users to agree on an amount of time that a transient chat session will last. It is contemplated that embodiments described herein may determine a type of conversation being held based at least in part upon the electronic device or the location of the electronic device. For example, a particular electronic device that belongs to a lawyer (attorney) or doctor may be configured such that at least one electronic device is able to determine that a conversation is taking place with a lawyer or doctor, and/or that the conversation may be confidential. As another example, if one electronic device is communicating from a particular location, such as a doctor's office, the electronic device may implement additional security measures. In some embodiments, additional security measures may be implemented, such as an extra layer of cryptography, to ensure that conversations between users where at least one user is a doctor, lawyer, member of the clergy, or other user that may require additional confidentiality are protected. Moreover, it is contemplated that transient messages as described herein may be used for “sexting.” For example, a couple may decide that they would like to send provocative media to one another. In such an example, an additional layer of security may be provided, or a user may be able to configure settings associated with an application as described herein to modify the amount of time particular pieces of media are available to another user. It is further contemplated that in some embodiments a user may be able to select a particular item of media that would not be erased/deleted after a chat session in response to the sender of the piece of media requesting that it not be erased/deleted.

FIG. 2E illustrates an exemplary embodiment of the interface 200 including messages 204, 206, 250 exchanged during regular, non-transient chat sessions. As shown in FIG. 2E, messages 204, 206, 250 that were exchanged either before or after a transient chat session may be displayed. In some embodiments, a chat session that took place prior to a transient chat session are erased.

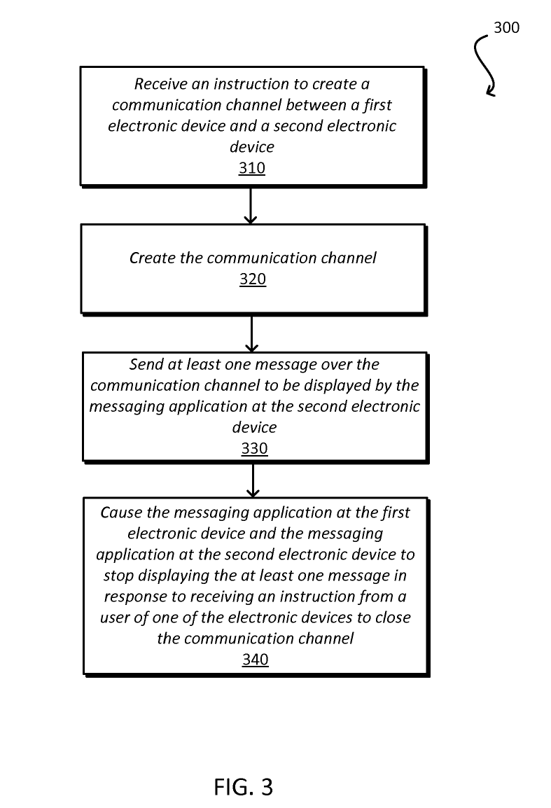

FIG. 3 illustrates an exemplary method embodiment for creating, using, and closing a transient chat room. It should be understood that method embodiments are shown for example only. Additional or fewer steps may be added or removed from the method embodiments shown herein. In addition, at least portions of the described method diagrams shown in FIG. 3 may be performed in a different order, in parallel, or not performed at all.

As shown, the method 300 begins at block 310, where an instruction is received to create a communication channel between a first electronic device and a second electronic device. An instruction to create a communication channel may be generated by a client device. For example, a communication channel may be created in response to a user opening a chat room with another user. This communication channel may utilize a peer-to-peer network. In some embodiments, a communication channel my use a point-to-point protocol and provide connection authentication, transmission encryption, and compression. In some embodiments, a server may host the communication between the users. In such a case, the instruction to create the communication channel may originate at the server. Hosting the chat on a server can be advantageous for private chats with multiple users.

In some embodiments a communication channel between a first electronic device and a second electronic device may exist prior to receiving an instruction to create a communication channel. For example, two users may be in a normal chat with each other, and then decide that they wish to switch to a transient chat session. In such an example, in some embodiments, the pre-existing communication channel may be terminated and a new communication channel may be created. In some embodiments the pre-existing communication channel switches to a transient chat mode (i.e., a chat mode where messages are stored on devices for a limited period of time).

At block 320, a communication channel is created. As described above, creating a communication channel includes, but is not limited to: creating a chat room, creating a chat session, establishing a virtual private network, establishing a network connection, etc. The channel may utilize a peer to peer network, or it may be hosted on a centralized server.

As described above, a communication channel may be created in response to a first client device sending a message to a second client device to set up a communication channel. The second device's user may be prompted to enter the transient chat session. In some embodiments, both devices must be running the same messaging application in order to enter a transient chat session. While in a transient chat session, certain resources may not be available to a user or the operating system of the user's device. For example, the transient chat application may execute in a sandbox, such that resources are restricted or unavailable to the application. In some embodiments, the application may send a message to an operating system instructing it to disable some of a device's features from interacting with the chat application. For example, cut and copy functionality may be restricted or disabled. Similarly, it is contemplated that the application may disable a device's ability to capture an image of visible items shown on the device's display (i.e., a “screen shot”).

At block 330, at least one message is sent over the communication channel to be displayed by the messaging application at the second electronic device. For example, messages, images, files, and other digital content may be transmitted from a first user to a second user within a transient chat room. At block 340, the messaging application at the first electronic device and the messaging application at the second electronic device stop displaying the at least one message exchanged during the transient chat session in response to receiving an instruction to close the communication channel (e.g., leave the transient chat room). In some embodiments, any electronic device 110, 120 may close the communication channel. When the transient chat session is over, the content transmitted during the conversation is deleted from the electronic devices 110, 120. This may include any server 150 or other electronic device that hosted the communications. In some embodiments, when a user (or a certain number of users) closes a transient chat session, there is nothing the other user(s) can do to save the content exchanged during the session (e.g., the chat messages or sent images). When an instruction is sent a user to shut down the communication channel the other devices are obligated to comply. For example, if a wife and husband are chatting and the wife ends the chat session, the chat room shown on the husband's device may close and the husband will be unable to retrieve any of the content exchanged during the conversation.

In some embodiments, the data exchanged between the users is stored in temporary memory, such that the memory is freed once the transient chat session ends. If the session took place in a sandbox, the entire sandbox may be deleted along with the data within the sandbox. In some embodiments, portions of data that were stored in non-volatile memory may be zeroed out.

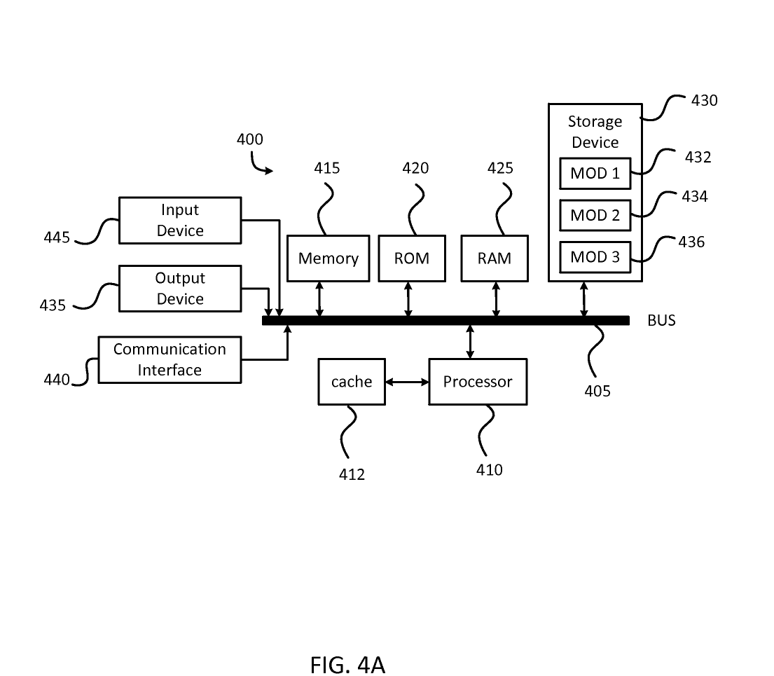

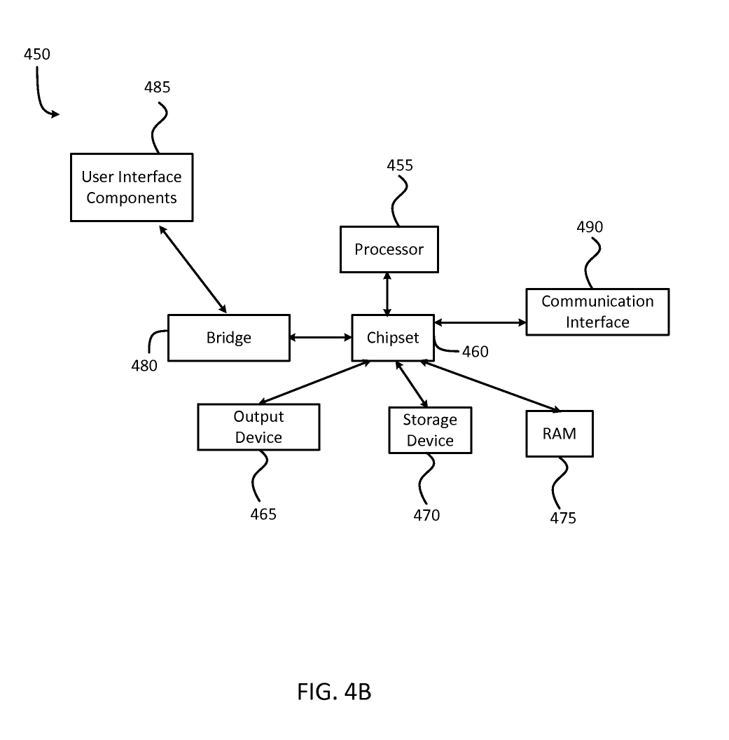

FIG. 4A, and FIG. 4B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 4A illustrates a conventional system bus computing system architecture 400 wherein the components of the system are in electrical communication with each other using a bus 405. Exemplary system 400 includes a processing unit (CPU or processor) 410 and a system bus 405 that couples various system components including the system memory 415, such as read only memory (ROM) 420 and random access memory (RAM) 425, to the processor 410. The system 400 can include a cache of high-speed memory connected directly with, in close proximity to, or integrated as part of the processor 410. The system 400 can copy data from the memory 415 and/or the storage device 430 to the cache 412 for quick access by the processor 410. In this way, the cache can provide a performance boost that avoids processor 410 delays while waiting for data. These and other modules can control or be configured to control the processor 410 to perform various actions. Other system memory 415 may be available for use as well. The memory 415 can include multiple different types of memory with different performance characteristics. The processor 410 can include any general purpose processor and a hardware module or software module, such as module 1 432, module 2 434, and module 3 436 stored in storage device 430, configured to control the processor 410 as well as a special-purpose processor where software instructions are incorporated into the actual processor design. The processor 410 may essentially be a completely self-contained computing system, containing multiple cores or processors, a bus, memory controller, cache, etc. A multi-core processor may be symmetric or asymmetric.

To enable user interaction with the computing device 400, an input device 445 can represent any number of input mechanisms, such as a microphone for speech, a touch-sensitive screen for gesture or graphical input, keyboard, mouse, motion input, speech and so forth. An output device 435 can also be one or more of a number of output mechanisms known to those of skill in the art. In some instances, multimodal systems can enable a user to provide multiple types of input to communicate with the computing device 400. The communications interface 440 can generally govern and manage the user input and system output. There is no restriction on operating on any particular hardware arrangement and therefore the basic features here may easily be substituted for improved hardware or firmware arrangements as they are developed.

Storage device 430 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 425, read only memory (ROM) 420, and hybrids thereof.

The storage device 430 can include software modules 432, 434, 436 for controlling the processor 410. Other hardware or software modules are contemplated. The storage device 430 can be connected to the system bus 405. In one aspect, a hardware module that performs a particular function can include the software component stored in a computer-readable medium in connection with the necessary hardware components, such as the processor 410, bus 405, display 435, and so forth, to carry out the function.

FIG. 4B illustrates a computer system 450 having a chipset architecture that can be used in executing the described method and generating and displaying a graphical user interface (GUI). Computer system 450 is an example of computer hardware, software, and firmware that can be used to implement the disclosed technology. System 450 can include a processor 455, representative of any number of physically and/or logically distinct resources capable of executing software, firmware, and hardware configured to perform identified computations. Processor 455 can communicate with a chipset 460 that can control input to and output from processor 455. In this example, chipset 460 outputs information to output 465, such as a display, and can read and write information to storage device 470, which can include magnetic media, and solid state media, for example. Chipset 460 can also read data from and write data to RAM 475. A bridge 480 for interfacing with a variety of user interface components 485 can be provided for interfacing with chipset 460. Such user interface components 485 can include a keyboard, a microphone, touch detection and processing circuitry, a pointing device, such as a mouse, and so on. In general, inputs to system 450 can come from any of a variety of sources, machine generated and/or human generated.

Chipset 460 can also interface with one or more communication interfaces 490 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 455 analyzing data stored in storage 470 or 475. Further, the machine can receive inputs from a user via user interface components 485 and execute appropriate functions, such as browsing functions by interpreting these inputs using processor 455.

It can be appreciated that exemplary systems 400 and 450 can have more than one processor 410 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, tablets, smart phones, wearable computers, televisions (e.g., smart-televisions), and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer-implemented method comprising:
receiving, in a messaging application at a first electronic device, an instruction to create a communication channel between the first electronic device and a second electronic device;
creating the communication channel;
sending, from the messaging application at the first electronic device, at least one message over the communication channel to be displayed by the messaging application at the second electronic device; and
in response to receiving an instruction to close the communication channel from a user of one of the electronic devices, causing the messaging application at the first electronic device and the messaging application at the second electronic device to stop displaying the at least one message.

2. The computer-implemented method of claim 1, wherein the at least one message to be displayed by the messaging application at the second device is stored in a memory, and
wherein causing the messaging application at the first electronic device and the messaging application at the second electronic device to stop displaying the at least one message further comprises:
deleting the at least one message from the memory.

3. The computer-implemented method of claim 1, further comprising:
determining that the second electronic device has taken a screen shot of a display of the second electronic device, the display including the at least one message; and
generating a notification indicating that the second electronic device has taken the screen shot of the display of the second electronic device including the at least one message.

4. The computer-implemented method of claim 1, further comprising:
sending an invitation to a second electronic device; and
receiving permission at the first device to create the communication channel between the first electronic device and the second electronic device.

5. The computer-implemented method of claim 1, further comprising:
receiving, in a messaging application at a first electronic device, an instruction to create additional communication channels between the first electronic device, the second electronic device, and at least a third electronic device.

6. The computer-implemented method of claim 1, wherein the instruction to close the communication channel is received from the first device or the second device.

7. The computer-implemented method of claim 1, wherein the message sent over the communication channel includes confidential information associated with an attorney, a religious figure, or a doctor.

8. The computer-implemented method of claim 1, further comprising:
receiving the instruction to close the communication channel at a particular point in time.

9. The computer-implemented method of claim 1, further comprising:
in response to creating the communication channel, disabling a cut function or a copy function configured to be performed by the first electronic device and the second electronic device.

10. A computer-implemented method comprising:
displaying a messaging application at a first electronic device;
receiving input causing the first electronic device to create a communication channel with a second electronic device;
sending one or more messages through the communication channel, wherein the first electronic device is configured to display the one or more messages, and wherein the one or more messages are configured to be displayed on a display of the second electronic device; and
in response the communication channel, deleting the one or more messages from the first electronic device.

11. The computer-implemented method of claim 10, wherein the one or more messages sent through the communication channel include information associated with an attorney, a religious figure, or a doctor.

12. The computer-implemented method of claim 11, further comprising:
in response to the communication channel closing, causing the second electronic device to delete the one or more messages.

13. The computer-implemented method of claim 12, wherein receiving an instruction from a user to close the communication channel comprises comprising:
receiving the instruction from a user of the first electronic device to close the communication channel.

14. The computer-implemented method of claim 12, wherein receiving an instruction from a user to close the communication channel comprises comprising:
receiving the instruction from a user of the second electronic device to close the communication channel.

15. The computer-implemented method of claim 10, further comprising:
determining that the second electronic device has taken a screen shot of the one or more messages; and
generating a notification indicating that the second electronic device has taken the screen shot.

16. The computer-implemented method of claim 10, wherein one or more messages consist of at least one of:
text, a video, audio, and an image.

17. A computing system comprising:
one or more processors;
a display; and
a memory device including instructions that, when executed by the one or more processors, cause the computing system to:
display a messaging application at the computing system;
receive input causing the computing system to create a communication channel with a remote computing system;
send one or more messages through the communication channel, wherein the computing system is configured to display the one or more messages on the display; and
in response receiving an instruction from a user of the computing system or a user of the remote computing system to close the communication channel, delete the one or more messages from the computing system.

18. The computing system of claim 17, wherein the one or more messages are configured to be displayed on a display of the remote computing system, and wherein the one or more messages are deleted from the remote computing system in response to the communication channel closing.

19. The computing system of claim 18, wherein the instruction to close the communication channel is received from a user of the computing system or the user of the remote computing system.

20. The computing system of claim 18, wherein the one or more messages sent through the communication channel include information associated with an attorney, a religious figure, or a doctor.
